(19) United States
(12) Patent Application Publication
(10) Pub. No.: US 2007/0288100 A1
(43) Pub. Date: Dec. 13, 2007

(54) Heat trace control panel

(76) Inventor: Stace Campbell, Kimberly, ID (US)

Correspondence Address: STOEL RIVES LLP - SLC, 201 SOUTH MAIN STREET, ONE UTAH CENTER, SALT LAKE CITY, UT, 84111, US

(21) Appl. No.: 11/788,594

(22) Filed: Apr. 19, 2007

Related U.S. Application Data
(60) Provisional application No. 60/793,050, filed on Apr. 19, 2006.

(51) Int. Cl. G05B 15/02

(52) U.S. Cl. 700/9

(57) ABSTRACT

A heat trace control panel to monitors heat trace control circuits for fault conditions. Upon occurrence of a fault condition in a heat trace control circuit an alarm is generated and the heat trace control circuit is monitored for a clear condition. Upon determination of a clear condition, the heat trace control circuit is reset automatically.

### RELATED APPLICATIONS

This application claims priority to U.S. Patent Application Ser. No. 60/793,050 filed on Apr. 19, 2007, entitled “Heat Trace Control Panel” and which is incorporate herein by reference.

### TECHNICAL FIELD

This disclosure relates generally to heat tracing systems and techniques for controlling and monitoring said systems.

### BRIEF DESCRIPTION OF THE DRAWINGS

Non-limiting and non-exhaustive embodiments of the disclosure are described, including various embodiments of the disclosure with reference to the figures, in which:

FIG. 1 is a block diagram of an embodiment of a heat trace control panel.

### DETAILED DESCRIPTION OF PREFERRED EMBODIMENTS

The described features, structures, or characteristics may be combined in any suitable manner in one or more embodiments. Those skilled in the art will recognize that the invention can be practiced without one or more of the specific details, or with other methods, components, materials, etc. In other instances, well-known structures, materials, or operations are not shown in detail to avoid obscuring aspects of the invention.

Furthermore, the described features, operations, or characteristics may be combined in any suitable manner in one or more embodiments. It will also be readily understood that the order of the steps or actions of the methods described in connection with the embodiments disclosed may be changed as would be apparent to those skilled in the art. Thus, any order in the drawing or Detailed Description is for illustrative purposes only and is not meant to imply a required order, unless specified to require an order.

Embodiments may include various steps, which may be embodied in machine-executable instructions to be executed by a general-purpose or special-purpose computer (or other electronic device). Alternatively, the steps may be performed by hardware components that include specific logic for performing the steps or by a combination of hardware, software, and/or firmware.

Embodiments may also be provided as a computer program product including a machine-readable medium having stored thereon instructions that may be used to program a computer (or other electronic device) to perform processes described herein. The machine-readable medium may include, but is not limited to, hard drives, floppy diskettes, optical disks, CD-ROMs, DVD-ROMs, ROMs, RAMs, EPROMs, EEPROMs, magnetic or optical cards, solid-state memory devices, or other types of media/machine-readable medium suitable for storing electronic instructions.

Several aspects of the embodiments described will be illustrated as software modules or components. As used herein, a software module or component may include any type of computer instruction or computer executable code located within a memory device. A software module may, for instance, comprise one or more physical or logical blocks of computer instructions, which may be organized as a routine, program, object, component, data structure, etc., that performs one or more tasks or implements particular abstract data types.

In certain embodiments, a particular software module may comprise disparate instructions stored in different locations of a memory device, which together implement the described functionality of the module. Indeed, a module may comprise a single instruction or many instructions, and may be distributed over several different code segments, among different programs, and across several memory devices. Some embodiments may be practiced in a distributed computing environment where tasks are performed by a remote processing device linked through a communications network. In a distributed computing environment, software modules may be located in local and/or remote memory storage devices. In addition, data being tied or rendered together in a database record may be resident in the same memory device, or across several memory devices, and may be linked together in fields of a record in a database across a network.

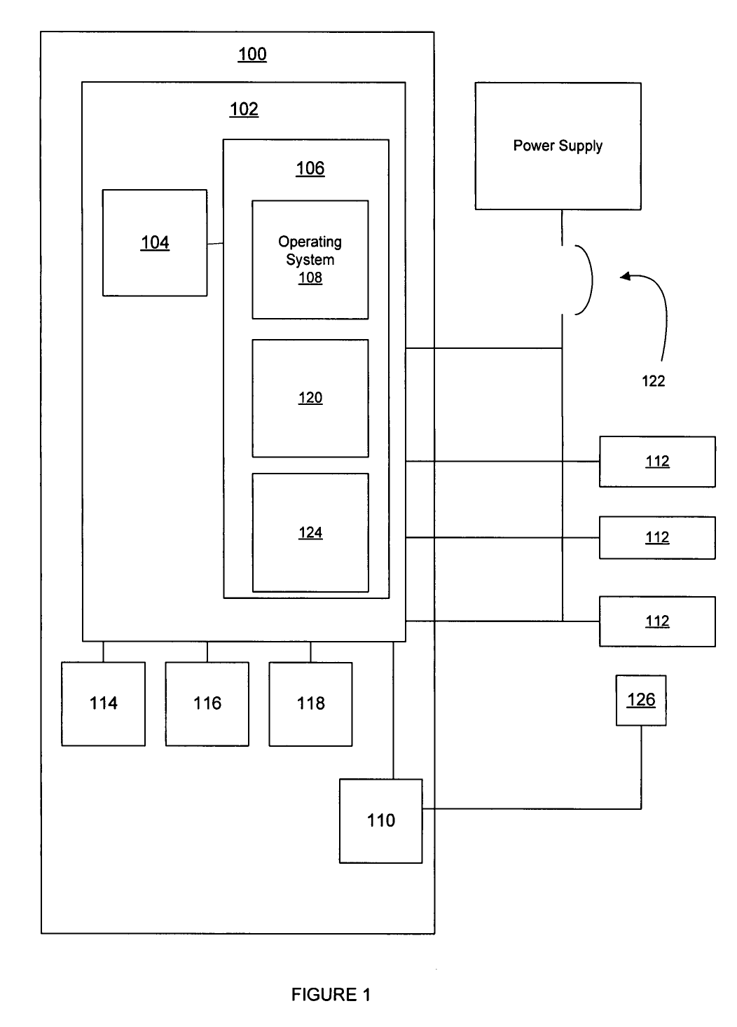

Referring to FIG. 1, a block diagram of an embodiment of a heat trace control panel 100 is shown. A heat trace control panel 100 is used in a variety of applications for systems that may include technology relating to self-regulation, constant wattage, mineral insulation, power-limiting cable, skin-effect tracing, impedance, induction, and circulating fluid tracing (i.e., steam, hot oil, or glycol), and other control and monitoring solutions. The heat trace control panel 100 may be configured for extended temperature ranges, dirty environments, and immunity to electrical noise. The heat trace control panel 100 is configured to provide cost-effective monitoring for ambient or line sensing temperature-controlled power distribution panels controlling large numbers of freeze protection or process maintenance heat tracing circuits. The heat trace control panel 100 may be configured to provide flexible power distribution, circuit alarms, line sensing, and ambient sensing controls.

The heat trace control panel 100 comprises a controller 102 such as a programmable logic controller. The controller 102 includes a microprocessor or microcontroller 104 which is in electrical communication with a memory 106. The memory 106 includes computer readable instruction code which may be identified as modules to practice the steps disclosed herein. The instruction code may be express decision logic as ladder logic.

The memory 106 may include non-volatile memory, RAM, ROM, and the like. The memory 106 may include an operating system 108 such as Microsoft ® Windows CETM to provide a versatile user interface.

The controller 102 may be in electrical communication with an interface 110 to enable communication with sensors, relays, and other devices. In one embodiment, the interface 110 includes input/output modules that may be coupled to a computer network to communicate with external devices.

The heat trace control panel 100 is in electrical communication with heat trace circuits 112 to detect a ground fault, overload condition, power termination, or other abnormalities. Upon detection of an abnormality event, the controller 102 identifies the heat trace circuit of concern and generates an alarm. In one embodiment, an enunciator panel may identify the faulted zone and ring the alarm.

The heat trace control panel 100 includes an output device 114 that may be embodied as any number of available monitors including an LCD incorporating thin film transistors to generate a 256-color graphical user interface. The output device 114 may also be embodied as a touch screen. An input device 116 is also provided and may include a keyboard, mouse, touch pad, touch screen, and the like.

In response to the alarm, the output 112 may display alarm information including the type of detecting abnormality, the identified heat trace circuit, the approximate location of the abnormality, and suggested or implemented action. This reduces troubleshooting and provides a better indication of potential problems on a heat trace circuit 112.

The heat trace control panel 100 may also include a network interface 118 for communicating with a LAN, WAN, or the internet. The network interface 118 can be compatible for SCADA and provides real-time monitoring and control for SCADA/DCS requirements. The network interface 118 may be configured for wireless communication for remote locations and for indoor facilities without telephone lines or even without commercial power. In one embodiment, the heat trace control panel 100 may include a radio modem configured for serial, field bus and/or Ethernet/IP data networks. The radio modem provides reliable communications in any industrial application. Alarm information may be sent to a remote computer for notification. Furthermore, through a remote computer remote monitoring and control of the heat trace control panel 100 may be enabled.

The controller 102 includes a line status monitoring module 120 that is configured to constantly look for fault conditions and abnormalities on the circuits 112. In the event of a fault, the monitoring module 120 identifies the circuit 112 and generates an alarm. The monitoring module 120 further monitors the circuit 112 for a clear condition. A clear condition is indicative of a return to normal operation and the absence of faults or abnormalities. The monitoring module 120 includes an automatic fault reset and re-energization logic. A user may be identified by alarm that a fault condition has occurred and, without any action by the user, the monitoring module 120 may determine that the fault condition no longer exists and reset the circuit 112. The monitoring module 120 may then generate a clear condition signal which is displayed on the output device 114.

Thus, if an upstream power failure occurs and then power resumes, the monitoring module 120 detects the restoration of power and resets the circuit automatically. In this manner, the controller 102 attempts to restore all heat trace circuits unattended. Thus, without direct user intervention, a circuit may be reset and restored.

The heat tracing circuits 110 may be monitored through a circuit breaker 122, through monitoring of the heat tracing current, or through parallel circuit continuity monitoring. With circuit breaker monitoring, the controller 102 is in electrical communication with one or more circuit breakers 122 to detect voltage loss. The controller 102 continuously monitors the status of voltage to each heat tracing circuit 112. The controller 102 is well suited to monitor the status of ground-fault branch circuit breakers. Any damage to the heating cable of a heat tracing circuit 112, or supply wiring that feeds a heat tracing circuit 112, which permits ground leakage current to trip an EPD breaker will signal an alarm condition.

For current loss monitoring, the controller 102 may, as an alternative or in conjunction with voltage monitoring, be in electrical communication with current sensing transformers. The integrity of constant wattage parallel or series of heating cables and power limiting parallel heating cables can be monitored by checking the magnitude of the current in the circuit using optional CT sensors. If a certain percentage of current loss occurs, such as 25%, the controller 102 signals an alarm condition.

For parallel circuit continuity monitoring, a parallel resistance heating cable may include a third wire for continuity monitoring. The controller 102 assures that voltage is being continuously supplied along an entire length of the heating cable in a heat tracing circuit 112. If the heating cable is cut or damaged when wired in this configuration, the controller 102 signals an alarm condition.

The heat trace control panel 100 may be embodied with integrated communications including TCP/IP, DeviceNet, Profibus, Modbus/Modbus+ and the like. The heat trace control panel 100 may communicate with conventional control systems including SCADA and DCS control systems. The heat trace control panel 100 is configured to monitor and control over 1500 heat trace circuits 110.

The controller 102 may be embodied as a modular unit and the heat trace control panel 100 may include a housing to serve as a suitable enclosure. The controller 102 may be configured with protocols to enable a broad range of communications with other controllers. The controller 102 may communicate with various programmable logic controllers, motion controllers, temperature controllers, and embedded micro-controllers.

The controller 102 may further include a conservation module 124 to conserve energy. The conservation module 124 stages circuit initiation and controls the start and stop of the heating process. The conservation module 124 avoids allowing the heat trace circuits to energize at the same time. This reduces the initial power demand and lessens the load on infrastructure. The conservation module 124 further provides conditional control of the heat trace circuits 112 once the desired temperature has been met. By using unique monitoring algorithms, the conservation module 124 can pulse the heat trace circuits to maintain the temperature and reduce power consumption.

The heat trace control panel 100 may further include additional support structure and devices such as solid date relays to reduce onsite assembly, labor, and wiring time by consolidating multiple functions into a modular design. It is anticipated that the components meet UL and cUL approvals, comply with NEC ground fault requirements. The heat trace control panel 100 may include panels such as NEMA 4, single-door, wall-mount enclosures for indoor and outdoor applications. Standard models are available in 12, 18, 20, 30 and 42 position panel boards with single and three-phase configurations. Branch circuits are available in 20, 25, 30, 40 and 50 amp single-pole and two-pole configurations with 30 mA ground-fault equipment protection.

Stainless steel enclosures and built-in heaters are available as options for harsh environments. Purge pressurization systems are also available for Class 1 Division 2 applications. The heat trace control panel 100 is configured to control heat trace lines with individual line sensing controls when required. Multiple sensors can be used to control individual circuits based on application and amperage.

The heat trace control panel 100 not only monitors the heat trace circuits 112, but also controls power delivery and distribution. In a fault condition, it may be determined by the monitoring module 120 that a circuit 112 may have been severed. For example, a human operator may cut a cable of a circuit 112 by mistake. As this condition may endanger a human operator, the controller 102 may immediately terminate power to the circuit 112. In so doing, human life may be spared.

The heat trace control panel 100 may be in communication with one or more external controller/thermostats 126 to provide line sensing control and enable ambient control of heat trace circuits. The thermostats 126 may communicate with the panel 100 through the interface 1 10. From the feedback provided by the thermostat 126, the control panel 100 may control heat in the heat trace circuits 1 12 and thereby control a temperature.

As disclosed herein the system continually monitors the supply voltage to each heat trace circuit. Loss of voltage, ground fault, or other abnormalities will trigger an automatic alarm condition. Individual heat trace lines may have line sensing controls for the desired heat generation. In certain embodiments, multiple sensors can be used to control individual circuits.

It will be obvious to those having skill in the art that many changes may be made to the details of the above-described embodiments without departing from the underlying principles of the invention.

What is claimed is:

1. A heat trace control panel to monitor a plurality of heat trace control circuits, comprising:
a controller comprising a memory including,
an operating system, and
a monitoring module to perform the method of,
monitoring each heat trace control circuit for a fault condition,
upon determination of a fault condition in an identified heat trace control circuit, monitoring the identified heat trace control circuit for a clear condition and generating an alarm, and
upon determination of a clear condition, automatically resetting the identified heat trace control circuit without user intervention; and
an output device in electrical communication with the controller and configured to display the generated alarm.

2. The heat trace control panel of claim 1, further comprising a network interface in electrical communication with the controller.

3. The heat trace control panel of claim 1, wherein monitoring each heat trace control circuit for a fault condition includes monitoring a circuit breaker for a voltage loss.

4. The heat trace control panel of claim 1, wherein monitoring each heat trace control circuit for a fault condition includes monitoring current loss in each heat trace control circuit.

5. The heat trace control panel of claim 1, wherein monitoring each heat trace control circuit for a fault condition includes monitoring parallel circuit continuity.

6. The heat trace control panel of claim 1, further comprising:
upon determination of a fault condition in the identified heat trace control circuit, terminating power to the identified heat trace control circuit.

7. The heat trace control panel of claim 6, wherein automatically resetting the identified heat trace control circuit includes restoring power to the heat trace control circuit.

8. The heat trace control panel of claim 1, wherein the memory further includes a conservation module to prevent simultaneous energization of the heat trace circuits.

9. The heat trace control panel of claim 1, wherein the memory further includes a conservation module to control pulses to each heat trace circuit to maintain a temperature and reduce power consumption.

10. The heat trace control panel of claim 1, further comprising a plurality of thermostats in electrical communication with the controller to provide temperature feedback, wherein each thermostat is disposed in proximity to a corresponding heat trace circuit.

11. A computer readable storage medium, having stored thereon computer readable instruction code for performing a method of monitoring a plurality of heat trace control circuits, the method comprising:
monitoring each heat trace control circuit for a fault condition;
upon determination of a fault condition in an identified heat trace control circuit, monitoring the identified heat trace control circuit for a clear condition and generating an alarm; and
upon determination of a clear condition, automatically resetting the identified heat trace control circuit without user intervention.

12. The computer readable storage medium of claim 11, wherein monitoring each heat trace control circuit for a fault condition includes monitoring a circuit breaker for a voltage loss.

13. The computer readable storage medium of claim 11, wherein monitoring each heat trace control circuit for a fault condition includes monitoring current loss in each heat trace control circuit.

14. The computer readable storage medium of claim 11, wherein monitoring each heat trace control circuit for a fault condition includes monitoring parallel circuit continuity.

15. The computer readable storage medium of claim 11, wherein the method further comprises:
upon determination of a fault condition in the identified heat trace control circuit, terminating power to the identified heat trace control circuit.

16. The computer readable storage medium of claim 15, wherein automatically resetting the identified heat trace control circuit includes restoring power to the heat trace control circuit.

17. The computer readable storage medium of claim 15, wherein the method further comprises non-simultaneously energizing the heat trace circuits to reduce power consumption.

18. A method of monitoring a plurality of heat trace control circuits, the method comprising:
monitoring each heat trace control circuit for a fault condition;
upon determination of a fault condition in an identified heat trace control circuit, monitoring the identified heat trace control circuit for a clear condition and generating an alarm; and
upon determination of a clear condition, automatically resetting the identified heat trace control circuit without user intervention.

19. The method of claim 18, wherein the method further comprises:
upon determination of a fault condition in the identified heat trace control circuit, terminating power to the identified heat trace control circuit.

20. The method of claim 19, wherein automatically resetting the identified heat trace control circuit includes restoring power to the heat trace control circuit.
